(19) United States
(12) Patent Application Publication
(10) Pub. No.: US 2010/0245040 A1
(43) Pub. Date: Sep. 30, 2010

(54) GARAGE DOOR OPENER TRANSMITTER WITH STATUS REPORTING

(76) Inventor: Kenneth J. Greves, Fort Myers, FL (US)

Correspondence Address: STANDLEY LAW GROUP LLP, 6300 Riverside Drive, Dublin, OH, 43017, US

(21) Appl. No.: 12/716,486

(22) Filed: Mar. 3, 2010

Related U.S. Application Data
(60) Provisional application No. 61/157,002, filed on Mar. 3, 2009.

(51) Int. Cl. G05B 19/04

(52) U.S. Cl. 340/5.71

(57) ABSTRACT

An improved garage door opener transmitter has a housing with a manually actuable member outside the housing. The transmitter actuating circuitry disposed in the housing. The transmitter circuit is adapted to send a signal to a receiver of a garage mounted opener unit to move a garage door having an open position and a closed position from a current position thereof to the other position. The improvement is a visually-observable indicium having first and second conditions. The indicium is connected to the actuable member and actuation thereof toggles the indicium from a current position thereof to the other position. In some embodiments, a non-visual indicium is also used.

### CROSS-REFERENCE TO RELATED APPLICATIONS

This application claims priority to U.S. provisional application No. 61/157,002 filed on Mar. 3, 2009 which is hereby incorporated by reference.

### TECHNICAL FIELD

The disclosed embodiments of the present invention relate to an improvement to a remote transmitter, typically a radio frequency (“RF”) transmitter, associated with a receiver for operating a device such as a garage door opener. The improved device uses the operation of the transmitter to toggle a status indicator between a first and a second state, providing a reminder to the user of the device.

### BACKGROUND OF THE ART

A number of US and foreign patents have described the typical garage door opener system that is installed in many households. The system commonly includes a manually actuable transmitter and a conventional garage mounted unit. The garage mounted unit has a door opening motor portion and a radio receiver portion. The motor portion conventionally includes a reversible motor connected through any convenient mechanical linkage, although typically a screw or chain, to a garage door to be opened and closed. A typical garage door used with the system is of the overhead type that comprises vertically stacked sections hinged in series and supported by rollers on a track fixed with respect to the garage. The motor portion includes suitable door position sensing means, such as limit switches, to provide the desired door operation. The radio receiver portion will include circuitry responsive to a radio signal of preselected kind received from the transmitter. Reception of the signal causes the motor portion to move the door from the existing one of its opened or closed positions to the other. The system will also be provided with safety features to prevent the motor from continuing to close the door on an object obstructing the closing of the door, although these further features are not pertinent to the present invention.

A preferred transmitter includes a housing of compact dimensions for hand-held use and for convenient storage in the glove compartment or behind the driver's sun visor in an automobile, or in a purse or the like. At least one manually actuable member, typically a push button, is conveniently accessible from outside the housing for actuating the transmitter circuitry disposed within the housing. Knowledge of the operation of particular transmitter circuitry is not particularly pertinent to the present invention, provided that a manual actuation of the actuable member causes a signal, preferably a radio frequency signal, to be sent to the receiver portion of the garage mounted unit. It is highly preferred to keep the communication between the transmitter and the receiver as simple as possible, within the obvious limits of providing a secure system that is not easily hacked by potential burglars, etc.

It is not uncommon for a person using a garage door opener system of this type to have a nagging concern about whether they remembered to close the garage door after they pulled out of the garage. This concern is reflected in some very complicated and costly systems for remotely monitoring the status of the garage door, such as that taught in U.S. Pat. No. 7,468,676, issued 23 Dec. 2008 to Styers. The solution there, which involves the modification of the garage mounted unit to interface with a cell phone and/or a computer, the installation of cameras to provide a remotely viewable image of the garage door, is simply far too complicated and expensive to be acceptable to many users of garage door opener systems.

It is therefore an unmet advantage of the prior art to provide an improvement to the transmitter used in a garage door opener system that reminds the user of the position status of the garage door and the operational status of the transmitter, without compromising the security features provided by one-way communication between the transmitter and the receiver portion of the garage mounted unit.

### SUMMARY OF THE INVENTION

The unmet advantage of the prior art is met by an improved garage door opener transmitter comprising an actuable member and a visually-observable indicium that is disposed on the transmitter's housing. In one embodiment, the indicium has a first and a second condition and is connected to the actuable member, such that each actuation of the member toggles the indicium from a current position thereof to the other position. Some embodiments comprising a visually-observable indicium further comprise a non-visually-observable indicium such as a vibrator or an audible notification.

Another embodiment of an improved garage door opener comprises a signal receiving means and a visually-observable indicium where said signal receiving means is in communication with the visually-observable indicium. The indicium preferably has a first and a second condition such that the signal receiving means toggles the indicium from a current position thereof to the other position upon receiving a signal. In some embodiments, the transmitting member comprises an actuable member actuation of which causes the transmitter to emit a radio wave. In such embodiments, the signal receiving means may receive radio wave signals emitted from the transmitter.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is a front elevation view of a transmitter as known in the prior art; and

FIG. 2 is a front elevation view of an embodiment of the improved transmitter.

### DETAILED DESCRIPTION OF A PREFERRED EMBODIMENT

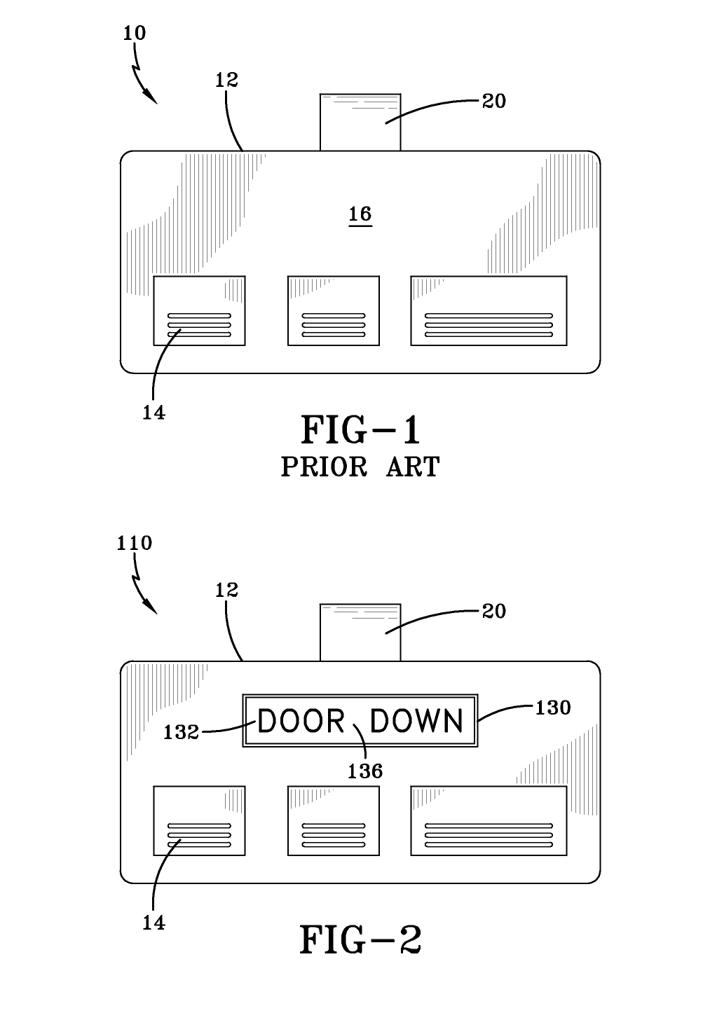

FIG. 1 shows an embodiment 10 of a transmitter of the type known in the prior art. The transmitter has a housing 12, which is usually compact and manufactured from a high-impact plastic. The housing 12 is sufficiently large to accommodate the circuitry, electrical power source and antenna required to emit a short-range signal, usually a radio frequency signal. The circuitry is tuned to generate a signal that is coded and/or of a frequency to actuate the motor portion of a garage mounted unit, once the receiver portion of the garage mounted unit receives the proper signal from a transmitter such as 10. The circuitry, etc., are not illustrated, as they are known in the art. The housing 12 also has at least one actuable member 14, such as a push button. This actuable member 14 is connected to the circuitry, so that depressing the push button results in the emission of the short range signal. Since the typical motor on a garage door opener is a simple reversible motor, only one type of signal is sent to the garage mounted unit receiver, with the receiver simply actuating the motor to operate in the reverse direction of its most recent operation. Access to the interior of the housing is typical accomplished through means disposed on a rear face of the housing, which is not shown.

While not shown in the illustrated embodiment, it is known to dispose a visual indicium, particularly an LED lamp, on the housing 12, and especially on a front face 16 of the housing, so that the user has an immediate positive feedback that the button 14 has been depressed sufficiently to send the signal. It is also known to provide an aural indicium, such as a buzzer, and even possibly a vibratory indicium. Again, due to the simple nature of the motor circuitry, sending rapidly sequential signals to the receiver can result in the door ocscillating between the two directions of its motion while never moving fully to the opposite condition from which it started. In some embodiments, the visual indicium of this type can be built directly into the actuable member. Any of these known indicia can also be utilized by the user to verify that the power source, typically a electrical cell, has sufficient power to generate the signal from the circuitry. These indicia are not able to indicate that the signal was either received by the receiver portion or that electrical power is available at the garage mounted unit to open or close the door.

Also shown in FIG. 1 is a portion of a clip 20, usually of metal, which may be useful in attaching the device 10 to a visor of the vehicle in which it is used.

Directing attention now to FIG. 2, an embodiment 110 of an improved transmitter is shown in front elevation view. To the extent that features are identical to those FIG. 1, the same reference numerals are used. For example, clip 20 is identical and housing 12 is substantial identical to that in FIG. 1, with the only change of note being the inclusion of a door status visual indicium area 130.

In the particular embodiment illustrated in FIG. 2, the door status visual indicium area 130 displays, in a first condition, the first message 132 “DOOR DOWN” (or a message of similar import). In a second (not illustrated) condition, the door status visual indicium area 130 would display a second message such as “DOOR UP” (or a message of similar import). The first and second messages would be displayed at least each time that the actuable member 14 is sufficiently depressed to send the signal to the receiver. In one embodiment, the messages displayed would be imprinted on a display member 136 that would rotate or otherwise change in a toggled manner and would be constantly displayed. In these embodiments, a mechanical connection between the actuable member 14 and the display member 136 could be used.

In another embodiment, the first and second messages could be electronically generated, with the same toggling effect of the displayed messages, based on depressions of the actuable member 14. One example for this would be a back-lit liquid crystal display (“LCD”). When the messages are electronically generated, it would be desirable to not display the message continually, in favor of extending the life of the power source. When the message is not continually displayed, it would be very desirable to provide a further actuable member, referred to hereinafter as the status button. When actuated, the status button would provide a visually observable signal for a predetermined period of time before extinguishing the message. Actuating the status button would not toggle the displayed message. Actuating the push button to send the signal would also generate the visually observable signal. In another variation on this theme, an LCD display of the current message could be constantly displayed, powered by a small electrical cell, such as a 1.55 V silver oxide cell, with the status button used to illuminate a light source, such as a light-emitting diode (“LED”) to back light the LCD display.

In a yet further embodiment, it is possible to provide a further button on the housing, which will be referred to as the “toggle button.” In some circumstances, such as initially aligning the status message with the door condition, or in later situations, as can occur when the use of other transmitters to change the door condition can result in disagreement between the status message and the door condition, the toggle button would toggle the state of the status message without sending a signal from the transmitter to the receiver portion. As there are only two conditions for each of the door and the status message, correcting any disagreement is easily accomplished.

It is desirable to be able to implement an improved transmitter as described above into existing garage opener systems, without entirely changing the system. In one option for accomplishing this, the internals of the existing transmitter may be able to be transferred into a new housing that provides the inventive features. In another option, the manufacturer of the original transmitter may be able to provide a new transmitter unit, in which the inventive features are incorporated, with the internal circuitry of the new transmitter tuned to duplicate the signal provided by the original transmitter. In a yet third option, the new transmitter may be internally equipped as a transponder, so that it can be “trained” by the original transmitter, in the manner taught in U.S. Pat. No. 7,469,129 to Blaker and assigned to Johnson Controls Technology Company. This third type of transmitter can, in some instances, be permanently installed in a vehicle and powered by the vehicle's battery.

In a yet further embodiment, a door status indicator can be associated with a pre-existing garage door opener transmitter 10. In this latter embodiment, the door status indicator would be in a separate housing that would preferably be attached to the transmitter 10, such as by using a strip of pressure sensitive adhesive. In such a status indicator, the indicator would toggle between messages such as “DOOR OPEN” and “DOOR CLOSED” by use of an actuator. Such as door status indicator could be similar in its toggle mechanism to that used in a “clicker”-type hand held device for counting attendance, etc. Such a device provides a very distinct detent position and an auditory “click” when used, thereby alerting the user of the actuation and positively retaining the displayed message.

One exemplary embodiment comprises a signal receiving means and a visually-observable indicium where the signal receiving means is in communication with the indicium. The indicium preferably has a first and a second condition. Upon receipt of a signal, the signal receiving means toggles the indicium from a first position to the other position. Such an embodiment may further comprise an actuable member actuation of which causes a radio wave frequency to be emitted from the transmitter. In these embodiments, the signal receiving means may comprise a radio-frequency retriever that receives the radio waves emitted from the transmitter. In another embodiment comprising a signal receiving means, an actuable member, and a visually-observable indicium, actuation of the member may cause an electronic signal to be sent to the signal receiving means. The electronic signal may be from a battery housed within the transmitter.

What is claimed is:

1. An improved garage door opener transmitter having a housing with a manually actuable member that is accessible from outside the housing for actuating a transmitter circuitry disposed within the housing, the transmitter circuit adapted to send a signal to a receiver of a garage mounted opener unit to move a garage door having an open position and a closed position from a current position thereof to the other position, the improvement comprising:
a visually-observable indicium, disposed on the housing, the indicium having a first and a second condition and being connected to the actuable member, such that each actuation of the member toggles the indicium from a current position thereof to the other position.

2. The transmitter of claim 1, further comprising:
an indicidum that is not visually observable.

3. The transmitter of claim 2, wherein:
the non-visually observable indicium is a vibrator.

4. The transmitter of claim 2, wherein:
the non-visually observable indicium is an audible notification.

5. The transmitter of claim 1, wherein:
the visually-observable indicium comprises a back-lit liquid crystal display.

6. An improved garage door opener transmitter having a housing with a manually actuable member that is accessible from outside the housing for actuating a transmitter circuitry disposed within the housing, the transmitter circuit adapted to send a signal to a receiver of a garage mounted opener unit to move a garage door having an open position and a closed position from a current position thereof to the other position, the improvement comprising:
a signal receiving means; and
a visually-observable indicium, disposed on the housing, the indicium having a first and a second condition, the indicium in electrical communication with the signal receiving means such that, the signal receiving means toggles the indicium from a current position thereof to the other position upon receiving a signal.

7. The transmitter of claim 6, further comprising:
an indicidum that is not visually observable.

8. The transmitter of claim 7, wherein:
the non-visually observable indicium is a vibrator.

9. The transmitter of claim 7, wherein:
the non-visually observable indicium is an audible notification.

10. The transmitter of claim 6, wherein:
the signal receiving means receives a first and a second signal, the first signal corresponding to the first condition of the visually-observable indicium and the second signal corresponding to the second condition of the visually-observable indicium.

11. The transmitter of claim 10, wherein:
receipt of the first signal by the signal receiving means toggles the visually-observable indicium to the first condition and receipt of the second signal by the signal receiving means toggles the visually-observable indicium to the second condition.

12. The transmitter of claim 11, wherein:
the first condition corresponds to the garage door being open and the second condition corresponds to the garage door being closed.

13. The transmitter of claim 5, further comprising:
a status button, electrically communicated to the back-lit liquid crystal display, and causing a temporary display of the current condition when actuated.

14. The transmitter of claim 6, wherein:
the signal receiving means comprises a radio-frequency receiver.

15. The transmitter of claim 1, further comprising:
a toggle button, in communication with the visually-observable indicium, causing the indicium to switch from the current position thereof to the other position, without actuation of the manually-actuable member.

16. The transmitter of claim 6, further comprising:
a toggle button, in communication with the visually-observable indicium, causing the indicium to switch from the current position thereof to the other position, without receiving a signal from the signal-receiving means.
